(19) United States
(12) Patent Application Publication
(10) Pub. No.: US 2025/0359708 A1
(43) Pub. Date: Nov. 27, 2025

(54) BOTTOM CHAMBER HANDLE FOR MOKA POT

(71) Applicant: Parker Roth, Naples, FL (US)

(72) Inventor: Parker Roth, Naples, FL (US)

(21) Appl. No.: 18/674,969

(22) Filed: May 27, 2024

(51) Int. Cl. A47J 45/07

(52) U.S. Cl. CPC A47J 45/078

(57) ABSTRACT

The present invention is a handle for the bottom chamber, or boiler, of a moka pot. This handle addresses the challenges of handling the hot bottom chamber and the difficulty of opening and closing the tightly sealed chambers. It allows users to safely manipulate and disassemble the bottom chamber while hot or warm, and provides a lever mechanism for increased torque, facilitating the efficient tightening and loosening of the bottom chamber. This novel invention enhances the usability and safety of moka pots.

### BACKGROUND

Moka pots, invented by Luigi De Ponti for Alfonso Bialetti in 1933, are a widely used method for brewing espresso-like coffee at home. These devices consist of three primary components: the bottom chamber (boiler), which holds water; the middle funnel that contains the coffee grounds; and the top chamber (collecting chamber) where the brewed coffee collects. When the water in the bottom chamber is heated, it produces steam pressure that forces the water up through the coffee grounds and into the top chamber.

Despite their widespread use and simple design, moka pots present two significant problems. First, the bottom chamber becomes very hot during brewing, making it difficult to handle. Users must wait for the pot to cool down before they can safely disassemble it. Second, the bottom chamber often becomes tightly sealed to the upper parts, making it hard to open. This difficulty can be attributed to residual steam pressure creating a vacuum effect, accumulation of coffee oils and mineral deposits on the threads, thermal expansion and contraction of the metal components, and general wear and tear on the threading over time.

Although there is a handle on the top chamber, there is no effective way to provide leverage on the bottom chamber, nor is there a means to handle it while it is still hot. These issues complicate the usability of the moka pot, making it challenging to open and handle the device safely and conveniently.

### SUMMARY OF THE INVENTION

The present invention is a handle for the bottom chamber, or boiler, of a moka pot. One embodiment includes a boiler built with an integrated handle, while another embodiment features a handle designed to couple with existing moka pots on the market. This innovation addresses two long standing issues in moka pot design: the difficulty of handling the hot bottom chamber and the challenge of opening and closing the tightly sealed chambers. The handle allows the user to manipulate and disassemble the bottom chamber while it is still hot or warm, providing a safe and effective solution for handling. Additionally, it offers a lever mechanism that enables the user to impart greater torque, making it easier to efficiently tighten and loosen the bottom chamber from the top. This invention is novel, as no one has previously added a handle to the bottom chamber of a moka pot. The spirit of the claims covers many embodiments, enhancing the usability and safety of the moka pot and offering a practical solution to problems that have persisted since the moka pot's inception.

### DESCRIPTION OF THE DRAWINGS

FIG. 1 is a prospective view of an embodiment of a bottom chamber handle coupled to a moka pot.

FIG. 2 is a prospective view of an embodiment of a prior art moka pot.

FIG. 3 is an exploded prospective view of an embodiment of a bottom chamber handle coupled to a moka pot.

FIG. 4 is a prospective view of an embodiment of a bottom chamber handle coupled to a moka pot.

FIG. 5 is an exploded prospective view of an embodiment of a bottom chamber handle uncoupled from a moka pot.

### DETAILED DESCRIPTION

A few of the preferred embodiments have been illustrated and described in detail. It is understood, however, that numerous modifications can be made without departing from the invention's scope as claimed. Those skilled in the art will recognize that many variations and substitutions may be made, qualifying as equivalents under the patent claims. The specific embodiments described herein are intended only to exemplify the invention and should not be seen as limiting its spirit or scope.

In the figures, not every element is assigned a reference number. Directional terms such as “forward,” “rearward,” “upper,” “lower,” “bottom,” “top,” and “side” are used to describe the orientation of the components as depicted in the drawings. Those skilled in the art will understand that these orientations may vary during actual use of the invention and are not intended to be limiting.

In this detailed description, the terms “bottom chamber 12” and “boiler” will be used interchangeably. Moka pot is interchangeable with a stove top espresso maker. “Handle” 10 and “Bottom Chamber Handle” 10 will be used interchangeably. Not all components commonly used in a moka pot, such as the gasket and filter, are labeled or required in this description. This omission is intentional because the invention does not alter the fundamental operation of the moka pot. The primary objective is to make the experience of using a moka pot safer and easier for the user in a novel way that has not been previously addressed.

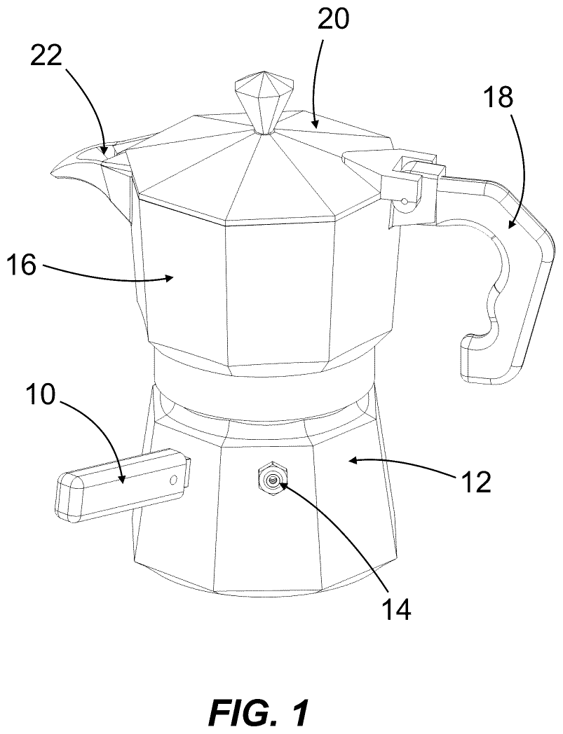

FIG. 1 is a perspective view of an embodiment of a bottom chamber handle 10 coupled to a moka pot. The moka pot comprises three primary components: the bottom chamber 12 (boiler), the middle funnel 26 containing the coffee grounds, and the top chamber 16 (collecting chamber) where the brewed coffee collects. The upper chamber and lower chamber are connected through a threaded interface. The lower chamber has an external thread 24, while the upper chamber has a corresponding internal thread. This threaded connection ensures a secure and tight seal, necessary to withstand the steam pressure generated during brewing. Between the upper and lower chambers, a rubber gasket and a metal filter plate are positioned. The gasket ensures an airtight seal, preventing steam or water from leaking during the brewing process. The filter plate allows the steam-pressurized water to pass through the coffee grounds in the middle funnel 26 and up into the upper chamber while keeping the coffee grounds contained.

To brew coffee, the bottom chamber 12 is filled with water. As the moka pot is heated on a stove, the water in the boiler heats up and produces steam pressure. This pressure forces the hot water up through the funnel 26 containing the coffee grounds. As the water passes through the coffee grounds, it extracts the coffee's flavors and aromas. The brewed coffee then continues to travel upward through a small tube and into the top chamber 16, where it is collected and ready to be served. This process creates a strong, espresso-like coffee that is characteristic of moka pot brewing.

In this embodiment, the handle 10 is integrated into the boiler, also known as the bottom chamber 12. The integrated handle 10 design facilitates easier manipulation and disassembly of the bottom chamber 12 while it is still hot or warm. Although this figure shows a fixed handle 10, alternative embodiments may feature handles 10 that fold or can be detached. Additionally, the handle 10 can serve multiple purposes or be integrated with other features. For example, the gas regulator 14 responsible for managing high pressure in the boiler may be extended or modified to function as a handle 10. This embodiment includes a polymer grip for heat resistance, enabling the user to safely handle 10 the boiler while it is hot. The integrated handle 10 enhances the usability and safety of the moka pot, providing a practical solution to the longstanding challenges of handling and opening the hot bottom chamber 12. Further embodiments may incorporate different materials and designs to accommodate various user needs and preferences.

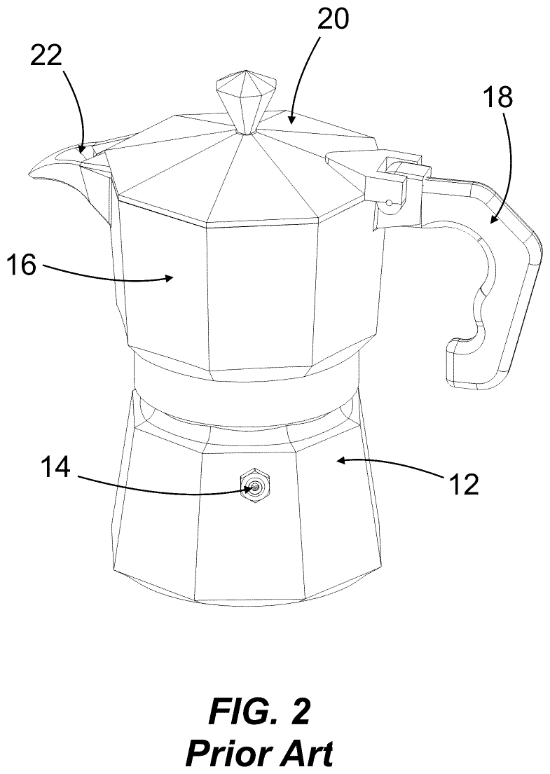

FIG. 2 is a perspective view of an embodiment of a prior art moka pot. This depiction illustrates the traditional design of moka pots that have been in use since their invention. The moka pot comprises three primary components: the bottom chamber 12 (boiler), the middle funnel 26 containing the coffee grounds, and the top chamber 16 (collecting chamber) where the brewed coffee collects. The top chamber 16 includes a spout 22 for pouring the brewed beverage, a lid 20, and an upper handle 18. In the prior art, there is no handle specifically designed for the bottom chamber 12 to aid in loosening it or manipulating it while it is hot. Users typically face significant challenges with this design. When the moka pot is heated, the boiler becomes extremely hot, making it difficult and unsafe to touch directly with bare hands. As a result, users often have to wait until the boiler cools down before attempting to disassemble it.

Furthermore, if the boiler becomes tightly sealed due to residual pressure, thermal expansion, or accumulation of coffee oils and mineral deposits, it can be very challenging to open. In the absence of an integrated handle, users may resort to using external tools or exerting significant force with their hands to loosen the boiler from the threaded connection. This process not only requires extra effort but also increases the risk of damaging the pot or injuring the user. The prior art moka pot design clearly lacks an effective solution for these problems, underscoring the need for an improved handle that can provide the necessary leverage and heat protection.

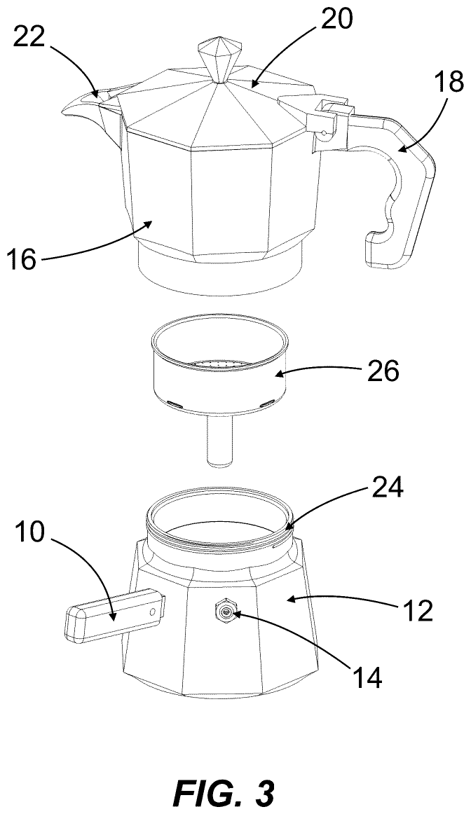

FIG. 3 is an exploded perspective view of an embodiment of a bottom chamber handle 10 coupled to a moka pot. This view illustrates how the components connect, which is not different from a traditional moka pot. The moka pot comprises the bottom chamber 12 (boiler), the middle funnel 26 containing the coffee grounds, and the top chamber 16 (collecting chamber) where the brewed coffee collects. In this embodiment, the integrated handle 10 is attached to the bottom chamber 12, enhancing usability without altering the basic connection method of the components.

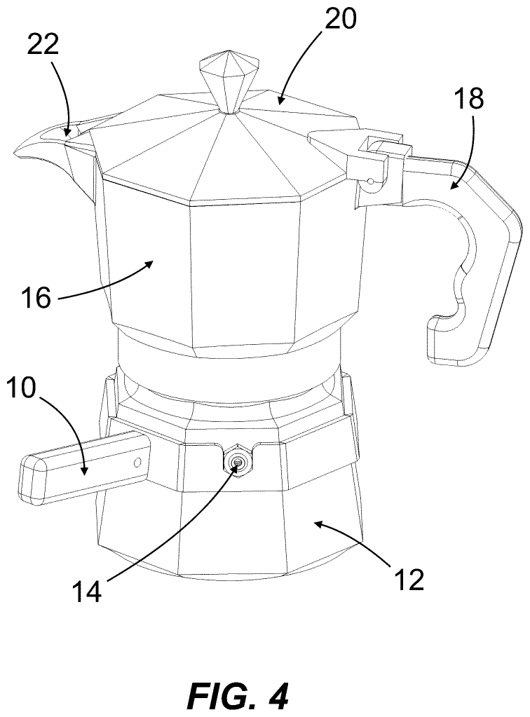

FIG. 4 is a perspective view of an embodiment of a bottom chamber handle 10 coupled to a moka pot. This embodiment demonstrates how a handle 10 can be retrofitted to an existing moka pot boiler. The handle 10 features an attachment that fits around the circumference of the boiler and sits beneath the gas regulator 14. This design shows one of many possible methods for attaching a handle 10 to an existing moka pot. The handle 10 provides leverage and heat resistance, making it easier to manipulate and disassemble the boiler while it is still hot or warm. This embodiment is illustrative and does not limit the scope of the claims; one skilled in the art can envision numerous ways to couple a handle 10 to various existing moka pot boilers. For example, the geometry securing the handle 10 to the boiler 12 that fits around the boiler 12 may double as a heat guard or insulator.

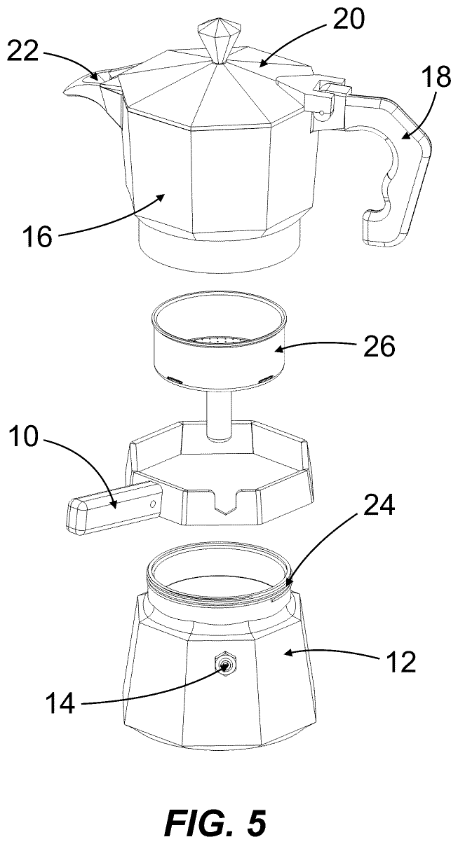

FIG. 5 is an exploded perspective view of an embodiment of a bottom chamber handle 10 uncoupled from a moka pot. This illustration shows how the boiler handle 10 is separate from the existing prior art boiler. The handle 10 is designed to retrofit onto an existing moka pot, providing leverage and heat resistance for easier manipulation and disassembly of the hot or warm boiler. This design demonstrates one method of coupling the handle 10 to the boiler without limiting the claims, as various methods can be envisioned by those skilled in the art.

What is claimed is:

1. A bottom chamber handle for a moka pot, comprising:
a handle coupled to the bottom chamber,
wherein the handle provides leverage to tighten and loosen the bottom chamber from the top chamber.

2. The bottom chamber handle of claim 1, wherein the handle is constructed of a heat-resistant material.

3. The bottom chamber handle of claim 1, wherein the handle is removable for cleaning and replacement.

4. The bottom chamber handle of claim 1, wherein the handle includes an ergonomic grip for user comfort.

5. The bottom chamber handle of claim 1, wherein the handle is foldable for compact storage.

6. The bottom chamber handle of claim 1, wherein the handle also functions as a gas regulator.

7. The bottom chamber handle of claim 1, wherein the handle is at least partially made of polymer.

8. The bottom chamber handle of claim 1, wherein the handle includes an integrated thermometer to measure the temperature of the bottom chamber.

9. The bottom chamber handle of claim 1, wherein the handle is designed to dissipate heat.

10. The bottom chamber handle of claim 1, wherein the handle is constructed at least partially of metal.

11. A bottom chamber handle for an existing moka pot, comprising:
a handle coupled to the bottom chamber,
wherein the handle provides leverage to tighten and loosen the bottom chamber from the top chamber.

12. The bottom chamber handle of claim 11, wherein the handle is adjustable to fit various sizes of moka pot bottom chambers.

13. The bottom chamber handle of claim 11, wherein the handle is constructed of a heat-resistant material.

14. The bottom chamber handle of claim 11, wherein the handle is removable for cleaning and replacement.

15. The bottom chamber handle of claim 11, wherein the handle includes an ergonomic grip for user comfort.

16. The bottom chamber handle of claim 11, wherein the handle replaces the existing gas regulator in location and function.

17. The bottom chamber handle of claim 11, wherein the handle is at least partially made of polymer.

18. The bottom chamber handle of claim 11, wherein the handle couples to the bottom chamber by mechanical means.

19. The bottom chamber handle of claim 11, wherein the handle couples to the bottom chamber and provides a heat guard function.

20. The bottom chamber handle of claim 11, wherein the handle couples to the bottom chamber by encircling the exterior surface of the bottom chamber and engaging with the gas regulator to prevent upward displacement.
